(19) United States
(12) Patent Application Publication
(10) Pub. No.: US 2022/0350797 A1
(43) Pub. Date: Nov. 3, 2022

(54) PROVIDING CONTAINER IMAGES

(71) Applicant: FUJITSU LIMITED, Kawasaki-shi (JP)

(72) Inventors: Max ARSENEAULT, East Palo Alto, CA (US); Wei-Peng CHEN, Fremont, CA (US)

(73) Assignee: FUJITSU LIMITED, Kawasaki-shi (JP)

(21) Appl. No.: 17/244,671

(22) Filed: Apr. 29, 2021

(51) Int. Cl. G06F 16/2455; G06F 16/22

(52) U.S. Cl. CPC G06F 16/2455; G06F 16/2246

(57) ABSTRACT

A method of providing a parent container image may include obtaining container image names, obtaining layer hashes, constructing a structured database, and returning a parent container image. The container image names may be of container images that include static executable software for running a process. The layer hashes may be obtained for each of the container images. The structured database may be based on relationships between the container images, which may be identified using the layer hashes. The parent container image may be returned in response to a query regarding a container image. The parent container image may be identified using the structured database.

### BACKGROUND

Software may be packaged into standardized units for development, shipment and deployment called containers or container images. A container image may include an unchangeable, static file that includes executable code so it can run an isolated process on information technology (IT) infrastructure. The container image may include of system libraries, system tools and other platforms settings a software program may use to run on a containerization platform such as Docker or CoreOS Rkt.

The subject matter claimed herein is not limited to embodiments that solve any disadvantages or that operate only in environments such as those described above. Rather, this background is only provided to illustrate one exemplary technology area where some embodiments described herein may be practiced

### SUMMARY

According to an aspect of an embodiment, a method of providing a parent container image may include obtaining container image names, obtaining layer hashes, constructing a structured database, and returning a parent container image. The container image names may be of container images that include static executable software for running a process. The layer hashes may be obtained for each of the container images. The structured database may be based on relationships between the container images, which may be identified using the layer hashes. The parent container image may be returned in response to a query regarding a container image. The parent container image may be identified using the structured database.

The object and advantages of the embodiments will be realized and achieved at least by the elements, features, and combinations particularly pointed out in the claims.

It is to be understood that both the foregoing general description and the following detailed description are exemplary and explanatory and are not restrictive of the claims.

### BRIEF DESCRIPTION OF THE DRAWINGS

Example embodiments will be described and explained with additional specificity and detail through the use of the accompanying drawings.

FIG. 1 is a flowchart illustrating an example method of providing a parent container image associated with a query container image.

FIGS. 2A-2D illustrate various construction revisions of an example structured database.

FIG. 3A illustrates another example structured database.

FIG. 3B illustrates a patch revision of the structured database of FIG. 3A.

FIG. 4 illustrates an example system that may be used for providing a parent container image associated with a query container image.

### DETAILED DESCRIPTION

When developers want to compose software containers, developers do not typically intend to compose the software containers from scratch. Rather, developers regularly build software containers based on an existing container image. A container image may include an unchangeable, static file that includes executable code so it can run an isolated process on a computing system. The container image may include system libraries, system tools and other platforms settings a program may use to run on a containerization platform on the computing system.

A container image may be formed from multiple different container image layers, referred to as container layers. The container layers may be other container images that have be complied together to form the container image. The container layers of a container image may be arranged in a parent-child relationship, such that each container layer includes one child layer and one parent layer. Thus, container layers of a current container image, which are other container images, may be described as a parent container images to the current container image. For example, a first image layer of a current container image may include multiple image layers. The first image layer may be a previous container image. One or more changes may be made to the previous container image and the one or more changes may be compiled with the previous container image to generate the current container image. The previous container image may be a parent container image of the current container image.

Each container image may include a parent container layer or image. The parent container layer may not include a further parent container layer or parent container image of the parent. A container image that has no parent container image may be referred to as a base image. In some embodiments, the base container layer may be a layer configured for a particular operating system type.

Information regarding parent container images may be used for making parent container image recommendations to developers. For example, if parent container images of existing container images are known, a recommendation system may recommend parent container images to developers to use as a basis for composing containers in response to receiving a query regarding description of their desired features. Alternately or additionally, with the information of parent container images a recommendation system may recommend similar container images to developers for them to customize the recommended container images to meet their requirements. For example, developers may customize a reconstructed container file to comply with requirements of an application to be developed.

In some circumstances, a container image may be associated with a container file. A container file may be used to generate the container image which includes the container layer of the container image. For example, the container file may include names of the container layers, which may be previous container images, and the order in which the container layers are compiled to form the container image. For example, a container file may include a FROM directive which generally identify the parent container images on which the container images associated with the container file are based. As such, a container file may provide parent container image information for a container image. However, major obstacles in automating recommendations of parent container images may include a lack of reliable datasets mapping container images to their parent container images, as in container files. Attempting to reconstruct container files using conventional tools may result in inaccurate container files. For instance, it may not be possible to build datasets of container files corresponding to particular versions of container images using conventional tools. For example, parent image information found in a posted container file may be outdated. In some instances, parent information may be inaccurate if a particular parent image identified as the latest has been updated and again identified as the latest since the child container file was generated. Alternately or additionally, not all versions of a container image may be available. For instance, developers may decline to publish all versions of their container images and some old versions of container images may no longer be available.

One conventional way to generate a sufficient dataset may involve mining container libraries, or container repositories, such as DockerHub and GitHub, for container files. However, conventional container libraries may provide insufficient or inaccurate information for generating effective datasets. For example, GitHub generally contains only the container files for the most recent version of a container image and may contain container files with high-level parent container images. Thus, for example, GitHub may provide a limited sample of container ancestries. Additionally, DockerHub may occasionally include container files with hosted container images. However, parent container image data found in available container files is often outdated. For instance, a container file may not include the information of specific version of its parent container image. Instead, only the keyword “latest” of version is configured in the container file. Nevertheless, once a newer version of the parent image is published, the information about the “latest” version in the above-mentioned container file is no longer valid. Furthermore, some versions of container images may be missing from DockerHub, which may provide incomplete data regarding container image ancestries.

Thus, for example, there are no conventional tools for consistently returning parent container images associated with given container images. Furthermore, conventional tools may require local pulls (requesting container images from a container repository), which may be time and space inefficient, may be error-prone, may fail to patch up missing nodes of the family tree, and may not reconstruct container files with FROM directives including the parent container images.

In some embodiments, parent-child container image relationships may be generated from publicly available container images. By way of example, parent-child container image relationships may be generated using a container image family tree generated using embodiments described herein. The parent-child container image relationships may facilitate container composition by developers. For instance, the parent-child container image relationships may be employed to recommend parent container images that developers may use as bases for building containers.

In some configurations of the systems and methods described herein, local pulls of container images from a repository may not be required for queries regarding information of container image. As such, developers may identify parent and ancestral container images from current container images using the systems and methods described herein. Upon identifying relevant parent container images, developers may adopt the relevant images as a parent container images and may add new development to compose new containers. Alternately or additionally, the generated container files may be employed to recommend container images similar to those developers wish to build. In some configurations, developers may modify the generated container files to meet requirements of their applications and may use the modified container files to receive parent container image recommendations. such recommendation systems offer an improvement over conventional efforts to identify relevant container images and parent container images, which may include using search functions to query container libraries based on container image names.

Embodiments will be explained with reference to the accompanying drawings.

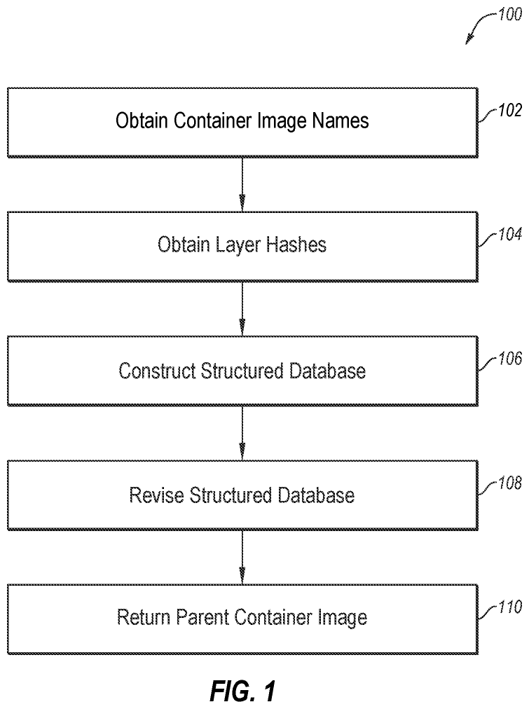

FIG. 1 is a flowchart illustrating an example method 100 of providing a parent container image. The parent container image may be associated with a query container image.

The method 100 may begin at step 102 by scraping a container library, such as DockerHub, GitHub, or the like. In some embodiments, container libraries may be scraped for official container image names, unofficial container image names, and/or tag equivalence classes. Scraping the container libraries may be used to obtaining multiple container image names of container images. In these and other embodiments, each of the container images may include static executable software for running a process.

In some embodiments, official container images may include container images that have been verified and may generally conform to container file best practices, which may result in robust container files associated with the container images. In some configurations, only unofficial container images associated with some threshold number of downloads may be scraped, such as unofficial container images associated with 10 million or more downloads. Alternately or additionally, container image names and/or tag equivalence classes may be obtained via a container application programming interface (API) request, described herein.

In some embodiments, scraping container libraries for official and/or unofficial container image names may be performed using Python API requests. Alternately or additionally, filters may be applied based on JavaScript Object Notation (JSON) responses. The “description” field of JSON responses may be stored for future use in parent container image recommendations.

Container images may be associated with hundreds to thousands of tags. Each API pull for a container image and its tag is performed individually and may be relatively expensive. Within a set of tags for a container image there may be equivalence classes of equivalent tags. Equivalent tags may reference synonymous container files or synonymous container images. To avoid pulling all tags, equivalent class of tags may be established. Each equivalent tag within an equivalent class may correspond to a same container file and associated container image. By way of example, a particular container image may be associated with the tags 16.04, 18.04, latest, bionic, focal, 20.04, 14.04, trusty, and xenial. The set of tags may include four equivalence classes including 20.04, focal, and latest as a first equivalence class; 14.04 and trusty as a second equivalence class; 16.04 and xenial as a third equivalence class; and 18.04 and bionic as a fourth equivalence class. The set of tags may be stored as a dictionary with the equivalence classes as disjoint sets. A representative tag may be selected for each equivalence class. In some embodiments, one representative tag per equivalence class may be considered.

To scrape tag equivalence classes of official container images, information associated with “supported tags and respective container file links” under “Description” tabs may be scraped from repositories of container images. For unofficial container images, tag equivalence classes may be constructed using tag names under “Tags” tabs with equivalent digests for fixed architectures. In some configurations, “shared tags” sections of container images pages may also be scraped. Tools that facilitate automated web browser navigation, such as Selenium, may be employed for scraping the “shared tags” sections of container images pages.

In some configurations, sets of container files may similarly be obtained. For instance, automated web browser navigation may be employed with official container images to navigate to the container library links used to construct the tag equivalence classes and may navigate to links associated with the listed tags for associated container files. Automated web browser navigation may be employed with unofficial container images to navigate to container file tabs for those unofficial container images that include associated container files. In some configurations, automated web browser navigation may be employed to search with container file tabs as Uniform Resource Locator (URL) extensions. For unofficial container images, associated container files may not be present, may be out of date, or may not include tags, potentially resulting in relatively poor ground truth datasets. However, available samples of container files associated with unofficial container images may function as validation metrics for algorithms described herein.

The method 100 may continue at step 104 by obtaining one or more layer hashes and layer histories associated with the official and/or unofficial container images of the container images names scraped from container libraries. In some embodiments, each of the layer hashes may include a hash of an image layer of one of the container images. In some configurations, the layer hashes may include file-system layer hashes. Additionally, layer histories associated with the container images may be obtained. Note that the layer hashes when obtained may include set of layer hashes. The set of layer hashes may not be organized in a manner to indicate an order that the image layers represented by the layer hashes in the set where used to construct the associated container image. Rather, the layer hashes may be randomly provided in the set such that the information that may be obtained from the set of layer hashes is the image layers used to generate a correspond container image.

Obtaining layer hashes and/or layer histories may be performed via a container API, such as container API. In some configurations, bash codes may be used to obtain authentication tokens to query the container API. In some embodiments, representational state transfer API (Restful API) requests may be employed and may be formatted according to container API documentation. The container API requests may obtain tag information and manifest files for the container images. The manifest files may be parsed into file-system layer hash sets and/or full layer histories. By way of example, the manifest files may be parsed via command-line tool jq or the like. In some embodiments, a container image and one representative tag per equivalence class may be employed to obtain an associated layer hash and layer history.

The method 100 may continue at step 106 by constructing a structured database of the container images based on relationships between the container images. The relationships between the container images may be identified using the one or more layer hashes for each of the container images. In these and other embodiments, the structured database of the container images is constructed without obtaining the container images and without using the container images. For example, the system and methods may not pull the container images from a container image repository or from memory to build the structured database. Rather, the structured database may be generated using the layer hashes without obtaining the corresponding container images.

The structured database may be a tree structure. The tree structure may include nodes that correspond to container images and/or container layers. The tree structure may be developed such that the tree structure includes a single parent node for every node in the structured database expect for a base node. The base node may not include a parent node. The base node may be associated with an operating system type. A parent node may include multiple children nodes. Thus, a parent node may represent a parent container image for a child node that is a container image. In these and other embodiments, the nodes between a current node and a base node may represent container images that may be used to construct a current container image that is represented by the current node.

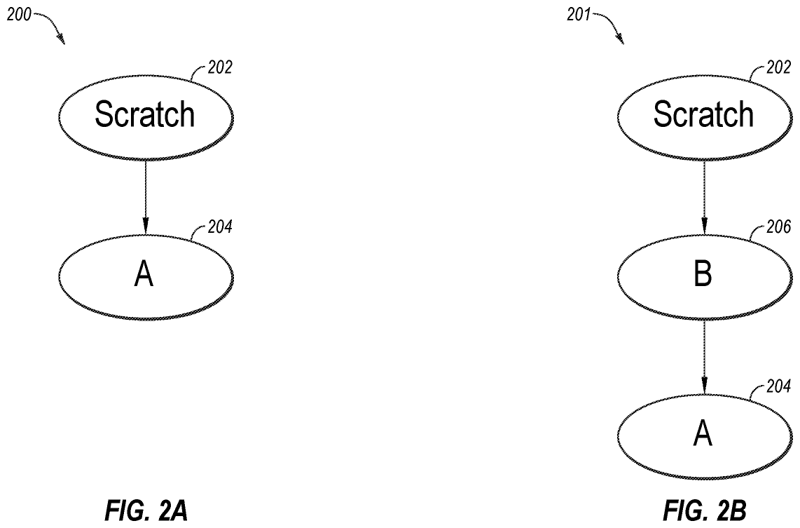

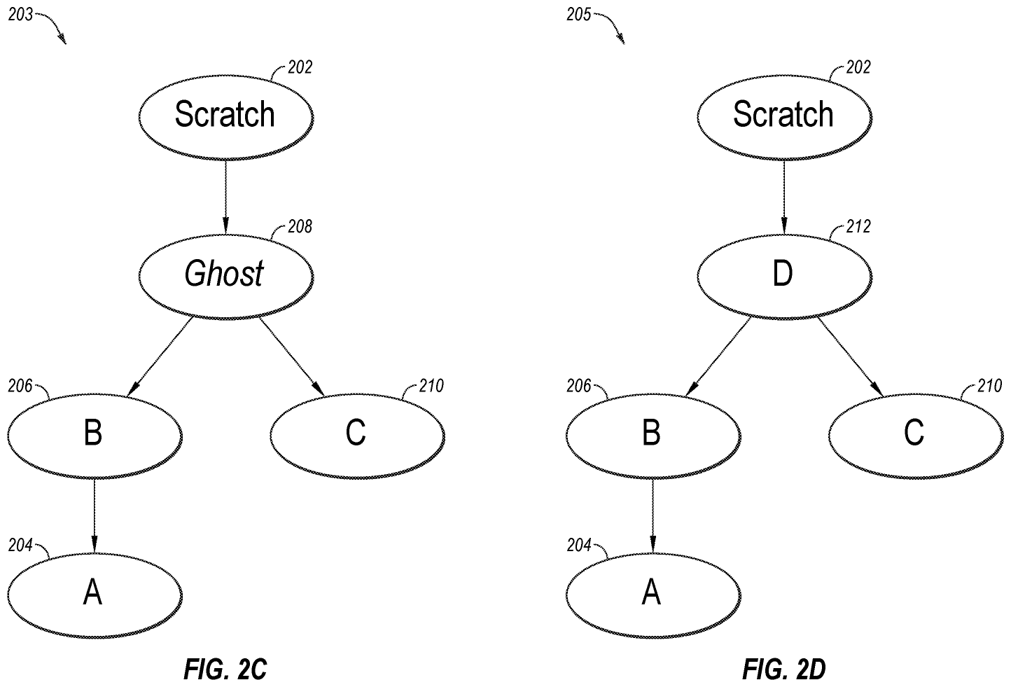

In some embodiments, the structured database may be based on a phylogenetic tree. Alternately or additionally, the structured database may be based on a Patricia trie or a variation of a Patricia trie. In some embodiments, each branching path of the Patricia trie may correspond to a substring. For instance, in some configurations, a letter in a stored word may correspond to an entire line of a container file. The structured database may include nodes connected by edges as may be seen in FIGS. 2A-2D and described generally herein. The edges of the structured database may correspond approximately to lines of c container files and/or image layers. The nodes of the structured database may correspond to container images. The structured database may merge non-root nodes with only one child into parent nodes. In some configurations, one representative tag from each equivalence class may be selected for construction of the structured database.

In some embodiments, construction of the structured database may include modeling each of the container images based on the layer hashes obtained for the container images. In these and other embodiments, the layer hashes for a container image may be a set of layer hashes. For example, each of the container images may be modeled as X={$, a₁, a₂, a₃, . . . aₙ}, where $ is a base token that denotes a base container layer or base node, which may also be denoted as a₀. In some configurations, each of the container images may include the $ token which may represent base container layer, in the associated layer history. The set of file-system layer hashes may be unordered, as the API may not return the hashes in order. In some configurations, each character aᵢ may correspond to a computed secure hash algorithm 256 (SHA-256) digest of an associated image layer.

The container images X may be inserted into a structured database data structure based on the layer hashes of all container images that are part of the structured database. The structured database may include a base node as a common ancestor to all container images represented in the structured database. Each node of the structured database excluding the base node may have a single predecessor.

In some embodiments, constructing the structured database of the container images may include positioning container images within the structured database based on comparisons of layered hashes associated with two or more container images. For example, intersections of a set of layer hashes of a container image to be inserted into the structured database and sets of layer hashes of container image in the structured database may be considered based on common ancestry of the sets of layered hashes to correctly file new container images into the structured database.

For example, a first container image, modeled as Q={$, a₁, a₂, a₃, . . . aₙ₋₁}, may be compared to a container image in the structured database, modeled as X={$, b₁, b₂, b₃, . . . , bₘ₋₁}. Thus, for instance, n may equal a number of layered hash elements associated with the container image Q and m may equal a number of layered hash elements associated with the container image X. An intersection of the container images, modeled as Q ∩ X={$, c₁, c₂, c₃, . . . , cₖ₋₁} may be computed, where k represents a number of layered hash elements that the container image Q and the container image X share. A baseline number of shared elements, represented as kₚᵣₑᵥ, may be set as 1 to reflect that each of the container images may include a base token in common and thus each intersection of container images may have at least one element in common. In some configurations, the overlap of the container image Q and the container image X may fall into one or more of five cases. The five cases may indicate how the container image Q may be positioned within the structured database with respect to the position of the container image X within the structured database.

In a first case, the container image Q and the container image X may not exhibit any overlap beyond the base token. That is, k=kₚᵣₑᵥ=1 for the intersection of the container image Q and the container image X. In this case, a correct placement location for the container image Q may not be available in the downstream branch of the structured database associated with the container image X. The container image Q may be compared to another branch, such as a sibling branch, of the structured database and the branch associated with the container image X may be marked as visited.

In a second case, the container image Q and the container image X may exhibit identical overlap. That is, k=m=n for the intersection of the container image Q and the container image X. In this case, the container image Q and the container image X may represent the same image. If the container image Q is a tag variant of the container image X, the container image Q may be noted as an alias of the container image X.

In a third case, the container image Q may be a descendent of the container image X. That is, k=m and m<n for the intersection of the container image Q and the container image X. In this case, the container image Q may be compared to container images previously identified as children of the container image X. If children of the container image X are not available in the structured database or if the container image Q is found not to belong in a branch of the children of the container image X, the container image Q may be included in the structured database as a child of the container image X.

In a fourth case, the container image Q may be an ancestor of the container image X. That is, k=n and n<m for the intersection of the container image Q and the container image X. In this case, the container image Q may be included in the structured database as a parent of the container image X. In particular, the container image Q may be spliced into the structured database between the previous parent of the container image X and the container image X.

In a fifth case, the container image Q and the container image X may share a common ancestor. That is, k<m and k<n for the intersection of the container image Q and the container image X. If the common ancestor has not yet been observed, a placeholder node, described herein as a ghost node, may be spliced into the structured database as a parent of both the container image Q and the container image X. If the common ancestor has been observed, the container image Q may be included in the structured database as a child of the common ancestor.

In some embodiments, the container image comparisons may be performed recursively. The container images at a given layer may be maintained in a stack. A breadth-first search may be performed at the first layer of the container images. If the stack is exhausted, the query container image Q may be included as a sibling node to the container images at that layer. For example, the container image Q may be located on a new branch descending from the base node if the container image Q is not found to belong to an existing branch.

FIGS. 2A-2D illustrate various construction revisions of an example structured database. FIG. 2A illustrates an initial structured database 200 where a container image A node 204 has been added to the structured database 200. As the container image A is the only container image represented in the structured database 200, a base node 202 is indicated as the parent of the container image A node 204. FIG. 2B illustrates an intermediate structured database 201 where container image B has been identified as an ancestor of the container image A and accordingly a container image B node 206 is located between the base node 202 and the container image A node 204. FIG. 2C illustrates another intermediate structured database 203 where container image C has been identified as sharing an ancestor with the container image B. Accordingly, a ghost node 208 is located between the base node 202 and the container image B node 206. The container image C node 210 is positioned as a child of the ghost node 208 and a sibling of the container image B node 206. FIG. 2D illustrates still another intermediate structured database 205 where a container image D has been identified as aₙ ancestor of the container image B and the container image C. Accordingly, the ghost node 208 of FIG. 2C is replaced by the container image D node 212.

With reference to FIG. 1, the method 100 may continue at step 108 by revising the structured database to address potential imperfections introduced during the construction of the structured database. In some embodiments, the structured database may be revised based on classification of tags associated with the layer histories or compilation data associated with the container images, the compilation data for a container image describing formation of the container image using layer histories of the container image. In some embodiments, compilation data may include a container file that is used to generate the container image using the image layers of the container image, Alternately or additionally, the compilation data may include a container history that is output by a system in response to generation of the container image using the image layers of the container image.

In some embodiments, the structured database may be patched via fuzzy ancestry, which may generally include breaking container files into fragments and comparing the resulting sets of fragments from a first container image to the resulting set of fragments from a second container image. Patching the structured database may include filling in ghost nodes, revising shared-layer errors, revising container images with base inaccurately identified as a claimed parent, and/or the like. Errors in the constructed structured database may be a result of errors or insufficiencies of container libraries from which the structured database is constructed. For instance, tag equivalence classes may age out of container libraries but may remain relevant to parent container images. Alternately or additionally, errors in the constructed structured database may result from lag between updates to an associated container registry and a command line interface (CLI). Alternately or additionally, near-identical container files that differ by a single word in an early line may result in layer hashes that do not overlap, which may result in inaccurate placement of container images in the structured database.

In some configurations, fuzzy ancestry may be employed to fill in ghost nodes or ghost images. Ghost nodes may represent common ancestors to container images where the particular container image associated with the common ancestor may not have been identified. Ghost images may often include unseen container image variants of official container images. In some embodiments, screening for ghost images that correspond to the ghost nodes may prioritize screening official container images and associated tag variants. In these and other embodiments, the names of the ghost images that correspond to the ghost nodes may not be known. However, general appearances of the ghost images may be known based on the layer histories of the container images that correspond to nodes that surround the ghost nodes.

In some embodiments, the container files of the known children of the ghost image may be broken up into sets of fragments and those sets of fragments may be compared to determine an intersection of the fragments. The intersection of the sets of fragments of the children container files may identify degrees of ancestral overlap between the children container images. These degrees of ancestral overlap may assist in identifying various patches for the structured database. For example, the intersection of sets of fragments from two or more container files of children container images may indicate a set of fragments that may be found in the container file of the ghost image.

By way of example, a container file child that includes the text “FROM ubuntu:16.04,” “RUN apt-get update,” and “RUN apt-get upgrade-y” may be broken up into a set of fragments including “FROM,” “ubuntu:16.04,” “RUN,” “apt-get,” “update,” “RUN,” “apt-get,” “upgrade,” and “-y” or the like. If the same fragments are found in another container file child, those same fragments may be likely to be found in the container file of the parent ghost image. The intersection of fragments from the two or more container files of children container images may be described herein as a parent query image.

In some embodiments, the parent query image may be employed to screen the container images of related nodes for candidates for the ghost node, such as cousin nodes, second-cousin nodes, aunt/uncle nodes, and the like. Alternately or additionally, a broad-spectrum panel may be employed and the parent query image may be screened against all of the container images and their variants in the structured database. In some configurations, the screening may consider what the tag of the parent container image may resemble and may not define a particular tag. A normalized Levenshtein similarity and/or a Jaccard similarity may be calculated to quantify a degree of similarity between the parent query image and the other container images in the structured database.

For instance, a normalized word-level Levenshtein distance may be calculated for a set of fragments of a container file A or a parent query image A and a set of fragments of a container file B as,

$$N ( A , B ) = \frac{Leven ( A , B )}{max ( \vert A \vert , \vert B \vert )}$$

where Leven(A,B) represents a word-level Levenshtein distance function, A represents the set of fragments of the container file A or the parent query image A, B represents the set of fragments of the container file B, and max(|A|, |B|)represents a set size of the larger set.

Alternately or additionally, a Jaccard similarity index may be calculated for a set of fragments of a container file A or a parent query image A and a set of fragments of a container file B as,

$$J ( A , B ) = \frac{\vert A ⋂ B \vert}{\vert A ⋃ B \vert}$$

where A represents the set of fragments of the container file A or the parent query image A and B represents the set of fragments of the container file B.

In some instances, a first container file may subsume a second container file, which may indicate that the second container file is an ancestor of the first container file. In some embodiments, an ancestral similarity may be calculated for a set of fragments of a container file A or a parent query image A and a set of fragments of a container file B as,

$$An ( A , B ) = \frac{\vert A ⋂ B \vert}{min ( \vert A \vert , \vert B \vert )}$$

where A represents the set of fragments of container file A or the parent query image A and B represents the set of fragments of the container file B. If the container image A, corresponding to the container file A, or the parent query image A is an ancestor of container image B, corresponding to container file B, then An(A,B) may equal 1.

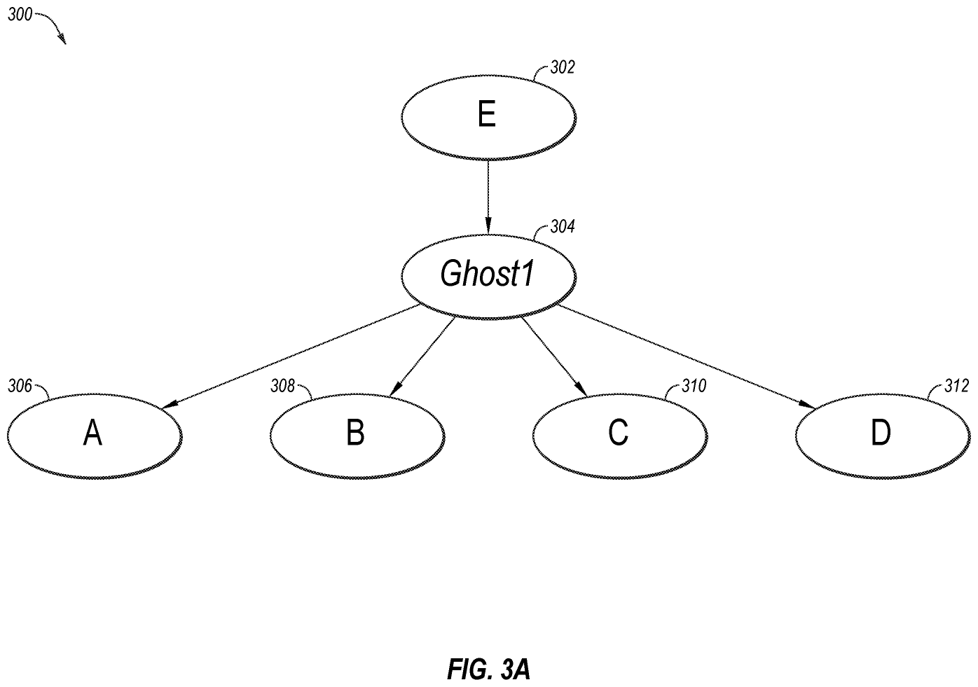

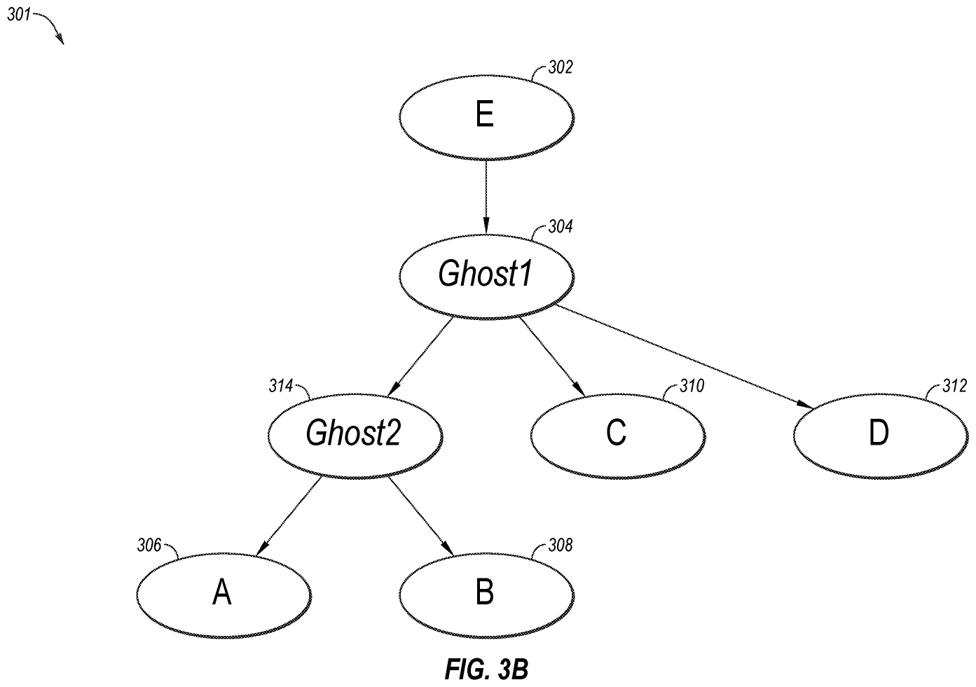

FIG. 3A illustrates a first example structured database 300. FIG. 3B illustrates a second example structured database 301, which may be a revision of the structured database 300. The structured database 300 illustrates a constructed structured database prior to revisions that includes a shared-layer error. The structured database 301 illustrates the structured database 300 following patching, which corrected the shared-layer error.

By way of example, a shared-layer error may arise where a container image C 310 and a container image D 312 may be tag variants of the same image while a container image A 306 and a container image B 308 may be descendants of an unseen tag variant of the container image C 310. For example, the container image C 310 and the container image D 312 may share a common parent container image, a container image E 302, and may share some initial container file lines. As the container file lines of the container image C 310 and the container image D 312 may share text and context, they may share layer hashes and overlap may be detected in construction of the structured database 300. A ghost node 1 304 may have been included in the structured database 300 as a theorized parent container image of the container image A 306, the container image B 308, the container image C 310, and the container image D 312 during the construction of the structured database.

However, the structured database 301 may be more accurate. Revising the structured database 300 via fuzzy ancestry may revise the structured database 300 to reflect the structured database 301. For example, an intersection of container file fragments associated with the container image C 310 and with the container image D 312, described in this example as parent query image W, may be generated. An ancestral similarity may be determined for the parent query image W relative to the container image A 306 and relative to the container image B 308. In response to the ancestral similarity indicating that all of the container file fragments of parent query image W are included in the container file fragments of image A 306 and of image B 308, the structured database 300 may be revised to include a ghost node 2 314 as a theorized parent of the container image A 306 and the container image B 308, as indicated by the structured database 301.

In some embodiments, fuzzy ancestry may be employed to address base-parent issues. During creation of a structured database, it may be difficult to distinguish between container images that have base container images as a parent container image and container images for which parent container images have incorrectly been identified as base container images. In some instances, due to this difficulty, a trail of ghost images may be followed up to a base node in an effort to identify an earliest non-ghost direct ancestor. The difficulty may be exacerbated where a slight update to an ancestral image layer changes an entire set of layer hashes. As a result, the container image may be placed as a descendent of the base container image rather than its correct placement in the structured database. Correct placement may be encouraged by performing a broad-spectrum screen against first-layer container images using ancestral similarity between the compilation data for the container image and the compilation data for the first-layer container images. The structured database may be revised to move container images to appropriate positions in response to the ancestral similarities being above a threshold. For instance, the structured database may be revised to show the container images as image variants of other container images. In some configurations, the tags may be queried for the best fits, as the similarities may vary between tags.

With reference to FIG. 1, the method 100 may continue at step 110 by returning a parent container image associated with a query container image using the structured database. For example, a query container image may be identified in the structured database. After identifying the query container image, a parent container image of the query container image may be identified using the structured database. Alternately or additionally, an indication of all parent container images between the base container image and the query container image may be identified.

In some embodiments, if the query container image is included in the structured database, the first non-ghost ancestor of the query container image may be returned from the structured database. Alternately, if the query container image is not included in the structured database, the layer hashes and layer histories of query container image may be pulled via an API pull, which may follow the same procedures of step 106 and/or step 108, and added to the structured database before returning the first non-ghost ancestor.

Additionally, in some embodiments, installed packages, such as those from rpm, pip, npm, apt-get, or the like may be extracted from container files associated with the parent container images. Text parsing the container files alone may be insufficient to capture all installed packages. Tools such as Google container-diff may be employed to examine the file systems of associated container images to extract such packages. However, such tools may exhibit package recall limitations that may be minimized by leveraging the structured database. For example, if an ancestor container image contains a package, the descendant container images are likely to include the same package unless it was deleted. Accordingly, the ancestral package info may be leveraged to improve recall of installed packages relative to text parsing alone.

For this and other processes and methods disclosed herein, the functions performed in the processes and methods may be implemented in differing order. Furthermore, the outlined operations are provided only as examples, and some of the operations may be optional, combined into fewer operations, or expanded into additional operations without detracting from the essence of the embodiments.

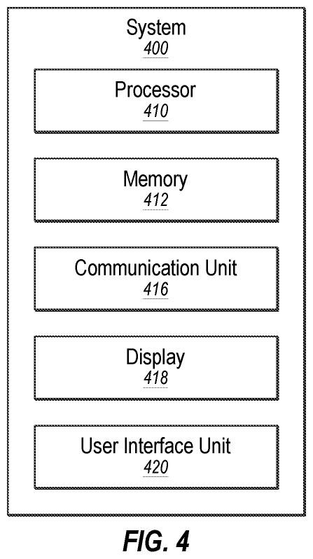

FIG. 4 is a block diagram illustrating an example system 400 that may be used for data clustering, according to at least one embodiment of the present disclosure. The system 400 may include a processor 410, memory 412, a communication unit 416, a display 418, and a user interface unit 420, which all may be communicatively coupled. In some embodiments, the system 400 may be used to perform one or more of the methods described in this disclosure.

For example, the system 400 may be used to perform one or more of the operations in the method 100 of FIG. 1.

Generally, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of networks or physical locations that are configured to perform individually or collectively any number of operations described herein. In some embodiments, the processor 410 may interpret and/or execute program instructions and/or process data stored in the memory 412. In some embodiments, the processor 410 may execute the program instructions stored in the memory 412.

For example, in some embodiments, the processor 410 may execute program instructions stored in the memory 412 that are related to task execution such that the system 400 may perform or direct the performance of the operations associated therewith as directed by the instructions. In these and other embodiments, the instructions may be used to perform one or more operations of the method 100 of FIG. 1.

The memory 412 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 410.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 410 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 416 may include any component, device, system, or combination thereof that is configured to transmit or receive information over a network. In some embodiments, the communication unit 416 may communicate with other devices at other locations, the same location, or even other components within the same system. For example, the communication unit 416 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 416 may permit data to be exchanged with a network and/or any other devices or systems described in the present disclosure.

The display 418 may be configured as one or more displays, like an LCD, LED, Braille terminal, or other type of display. The display 418 may be configured to present video, text captions, user interfaces, and other data as directed by the processor 410.

The user interface unit 420 may include any device to allow a user to interface with the system 400. For example, the user interface unit 420 may include a mouse, a track pad, a keyboard, buttons, camera, and/or a touchscreen, among other devices. The user interface unit 420 may receive input from a user and provide the input to the processor 410. In some embodiments, the user interface unit 420 and the display 418 may be combined.

Modifications, additions, or omissions may be made to the system 400 without departing from the scope of the present disclosure. For example, in some embodiments, the system 400 may include any number of other components that may not be explicitly illustrated or described. Further, depending on certain implementations, the system 400 may not include one or more of the components illustrated and described.

As indicated above, the embodiments described herein may include the use of a special purpose or general-purpose computer (e.g., the processor 410 of FIG. 4) including various computer hardware or software modules, as discussed in greater detail below. Further, as indicated above, embodiments described herein may be implemented using computer-readable media (e.g., the memory 412 of FIG. 4) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the scope of the present disclosure.

What is claimed is:

1. A method of providing a parent container image, the method including:
obtaining a plurality of container image names of container images, each of the container images including static executable software for running a process;
obtaining one or more layer hashes for each of the container images corresponding to the plurality of container image names, each of the layer hashes including a hash of aₙ image layer of one of the container images;
constructing a structured database of the container images based on relationships between the container images, the relationships between the container images identified using the one or more layer hashes for each of the container images; and
in response to a query regarding a first container image, returning a parent container image of the first container image, the parent container image identified using the structured database.

2. The method of claim 1, wherein the structured database of the container images is constructed without obtaining the container images and without using the container images.

3. The method of claim 1, wherein the structured database is based on a tree structure with every node in the tree structure including a single parent node except a base node.

4. The method of claim 1, wherein constructing the structured database of the container images includes positioning container images within the structured database based on comparisons of layered hashes associated with two or more container images.

5. The method of claim 4, wherein constructing the structured database of the container images includes comparing a first set of layer hashes corresponding to a first container image not positioned within the structured database to a second set of layer hashes corresponding to a second container image positioned within the structured database, wherein:
a lack of non-base layer overlap between the first set of layered hashes and the second set of layered hashes indicates that the first container image is not located in a branch of the structured database associated with the second container image,
identical overlap between the first set of layered hashes and the second set of layered hashes indicates that the first container image and the second container image are the same, and
partial overlap between the first set of layered hashes and the second set of layered hashes, where all layered hashes of the first set of layered hashes are included in the second set of layered hashes indicates that the second container image is a descendant of the first container image in the structured database.

6. The method of claim 4, wherein constructing the structured database of the container images includes comparing a first set of layer hashes corresponding to a first container image not positioned within the structured database to a second set of layer hashes corresponding to a second container image positioned within the structured database, wherein:
partial overlap between the first set of layered hashes and the second set of layered hashes, where all layered hashes of the first set of layered hashes are not included in the second set of layered hashes, and where all layered hashes of the second set of layered hashes are not included in the first set of layered hashes indicates that the first container image and the second container image share a common ancestor in the structured database,
wherein where it is indicated that the first container image and the second container image share a common ancestor that is not part of the structured database, constructing the structured database includes positioning a placeholder node in the structured database as a parent to the first container image and the second container image.

7. The method of claim 1, further comprising revising the structured database based on classification of tags associated with the layer hashes or compilation data associated with the container images, the compilation data for a container image describing formation of the container image using layer hashes of the container image.

8. The method of claim 7, wherein the compilation data is a container file that is used to generate the container image using the image layers of the container image.

9. The method of claim 7, wherein the compilation data is a container history that is output by a system in response to generation of the container image using the image layers of the container image.

10. The method of claim 7, wherein revising the structured database based on the compilation data associated with the container images includes:
identifying a first container image and a second container image with a placeholder node as a parent container image in the structured database, the placeholder node indicating that a parent container image exists but is not yet identified;
comparing the compilation data of the first container image to the compilation data of the second container image to determine layer characteristics of the placeholder node; and
comparing the layer characteristics of the placeholder node to layer characteristics of the container images to identify the placeholder node or layer characteristics of the placeholder node.

11. The method of claim 10, wherein revising the structured database based on the compilation data associated with the container images further includes creating a second placeholder node as a parent node for the first container image and second container image based on a comparison of the layer characteristics of the placeholder node to layer characteristics of the container images.

12. A non-transitory computer-readable medium having encoded therein programing code executable by a processor to perform operations comprising:
obtaining a plurality of container image names of container images, each of the container images including static executable software for running a process;
obtaining one or more layer hashes for each of the container images corresponding to the plurality of container image names, each of the layer hashes including a hash of an image layer of one of the container images;
constructing a structured database of the container images based on relationships between the container images, the relationships between the container images identified using the one or more layer hashes for each of the container images; and
in response to a query regarding a first container image, returning a parent container image of the first container image, the parent container image identified using the structured database.

13. The non-transitory computer-readable medium of claim 12, wherein the structured database of the container images is constructed without obtaining the container images and without using the container images.

14. The non-transitory computer-readable medium of claim 12, wherein constructing the structured database of the container images includes positioning container images within the structured database based on comparisons of layered hashes associated with two or more container images.

15. The non-transitory computer-readable medium of claim 14, wherein constructing the structured database of the container images includes comparing a first set of layer hashes corresponding to a first container image not positioned within the structured database to a second set of layer hashes corresponding to a second container image positioned within the structured database, wherein:
a lack of non-base layer overlap between the first set of layered hashes and the second set of layered hashes indicates that the first container image is not located in a branch of the structured database associated with the second container image,
identical overlap between the first set of layered hashes and the second set of layered hashes indicates that the first container image and the second container image are the same, and
partial overlap between the first set of layered hashes and the second set of layered hashes, where all layered hashes of the first set of layered hashes are included in the second set of layered hashes indicates that the second container image is a descendant of the first container image in the structured database.

16. The non-transitory computer-readable medium of claim 14, wherein constructing the structured database of the container images includes comparing a first set of layer hashes corresponding to a first container image not positioned within the structured database to a second set of layer hashes corresponding to a second container image positioned within the structured database, wherein:
partial overlap between the first set of layered hashes and the second set of layered hashes, where all layered hashes of the first set of layered hashes are not included in the second set of layered hashes, and where all layered hashes of the second set of layered hashes are not included in the first set of layered hashes indicates that the first container image and the second container image share a common ancestor in the structured database,
wherein where it is indicated that the first container image and the second container image share a common ancestor that is not part of the structured database, constructing the structured database includes positioning a placeholder node in the structured database as a parent to the first container image and the second container image.

17. The non-transitory computer-readable medium of claim 12, the operations further comprising revising the structured database based on classification of tags associated with the layer hashes or compilation data associated with the container images, the compilation data for a container image describing formation of the container image using layer hashes of the container image.

18. The non-transitory computer-readable medium of claim 17, wherein the compilation data is a container file that is used to generate the container image using the image layers of the container image.

19. The non-transitory computer-readable medium of claim 17, wherein the compilation data is a container history that is output by a system in response to generation of the container image using the image layers of the container image.

20. The non-transitory computer-readable medium of claim 17, revising the structured database based on the compilation data associated with the container images includes:
identifying a first container image and a second container image with a placeholder node as a parent container image in the structured database, the placeholder node indicating that a parent container image exists but is not yet identified;
comparing the compilation data of the first container image to the compilation data of the second container image to determine layer characteristics of the placeholder node; and
comparing the layer characteristics of the placeholder node to layer characteristics of the container images to identify the placeholder node or layer characteristics of the placeholder node.
